(19) United States
(12) Patent Application Publication
(10) Pub. No.: US 2024/0272021 A1
(43) Pub. Date: Aug. 15, 2024

(54) DISTRIBUTED STRAIN SENSING USING CAPACITOR WITH VARIABLE-RESISTANCE ELECTRODES AND METHOD

(71) Applicant: KING ABDULLAH UNIVERSITY OF SCIENCE AND TECHNOLOGY, Thuwal (SA)

(72) Inventors: Hussein NESSER, Thuwal (SA); Gilles LUBINEAU, Thuwal (SA)

(21) Appl. No.: 18/565,196

(22) PCT Filed: Jun. 17, 2022
(86) PCT No.: PCT/IB2022/055666

§ 371 Date: Nov. 29, 2023

Related U.S. Application Data
(60) Provisional application No. 63/312,899, filed on Feb. 23, 2022.
(60) Provisional application No. 63/213,266, filed on Jun. 22, 2021.

(51) Int. Cl. G01L 1/14

(52) U.S. Cl. CPC G01L 1/146

(57) ABSTRACT

A strain characterization system includes a strain sensor having first and second electrodes that sandwich a dielectric layer to form a capacitor; a power source configured to inject a signal V_{AC} between the first and second electrodes of the strain sensor; and a controller configured to control the power source and to select a frequency of the power source. The controller is configured to select first to third different frequencies for determining a strain magnitude, a strain location, and an extent of a strain area.

### CROSS-REFERENCE TO RELATED APPLICATIONS

This application claims priority to U.S. Provisional Patent Application No. 63/213,266, filed on Jun. 22, 2021, entitled “MINIMIZING THE WIRING IN DISTRIBUTED STRAIN SENSING USING A CAPACITIVE SENSOR SHEET WITH VARIABLE-RESISTANCE ELECTRODES,” and U.S. Provisional Patent Application No. 63/312,899, filed on Feb. 23, 2022, entitled “MINIMIZING THE WIRING IN DISTRIBUTED STRAIN SENSING USING A CAPACITIVE SENSOR SHEET WITH VARIABLE-RESISTANCE ELECTRODES,” the disclosures of which are incorporated herein by reference in their entirety.

### BACKGROUND

### Technical Field

Embodiments of the subject matter disclosed herein generally relate to a strain sensor and method for determining strain characteristics, and more particularly, to a variable-resistance electrode-based sensor that is capable not only to determine a strain intensity present in a given target, but also where the strain is located and an extents of the strained area.

### Discussion of the Background

Strain sensors are widely applied today in smart wearable applications, structural health monitoring (SHM), human motion detection, soft robotics, medical treatments, and human-machine interfaces. Distributed strain sensing, i.e., the ability to measure strains at different locations, has become especially important in modern sensing devices. For example, accurate measurement of human motion is essential for interactions with a virtual environment. A high spatial resolution is required for detecting expected damage locations in structures. Also, spatial/distributed strain detection is necessary for applications involving shape change (morphing) and/or large surface areas. Spatial coverage (ability to cover a large area) and spatial resolution (ability to detect strain at accurate location) become very important in such applications and currently there is no single sensor that can measure both the spatial coverage and the spatial resolution.

To date, large-area sensing with high spatial resolution has not been achieved due to serious technical limitations. For example, an optical method based on fiber Bragg grating (FBG) is a popular technique used in distributed strain sensing. Although multiplexing of FBGs is now a well-controlled technique, FBGs are thermally sensitive; moreover, despite the development of compensation techniques, the wavelength shifts caused by temperature and strain cannot be easily distinguished over large areas. Further, FGBs rely on expensive and bulky interrogation systems.

Another solution uses electrical strain sensors, which implement a network of independent plural sensors on a large surface, but the number of electronic interfaces is directly related to the number of sensors. A capacitive tactile-sensor array can reduce the numbers of cables and electronic interfaces. Two-dimensional (2D) sensor arrays on a single sheet have been developed by patterning the electrodes on the bottom and top of the dielectric material into orthogonal columns and rows, thus creating pixels at the intersections. Nevertheless, the resolution of this approach is limited and detecting the capacitance variation at a specific pixel requires a complex electronic interface using analog multiplexers, decoders, and capacitance-to-digital converters.

If the sensor is configured to behave as an analogical transmission line, multiple sensing regions can be created within the area of a single capacitive sensor body, simplifying the electronic interface, see [1] to [4]. According to this approach, the sensing signal is attenuated by the high-resistance electrodes along the capacitive sensor's length. Different regions of the capacitive sensor can then be sensed by changing the sensing frequency. As demonstrated in [3], capacitive sensing based on the transmission-line model can realize 2D touch detection by a stretchable keyboard. Applying the same method, [2] detected the pressure on pixels using a single-sensor body and a single electronic interface. However, these devices are not configured to measure both the spatial coverage and the spatial resolution of the strain.

Thus, there is a need for a sensor and an associated processing algorithm for overcoming the complexity of the above discussed systems, and also being able to measure both the spatial coverage and the spatial resolution associated with the strain.

### BRIEF SUMMARY OF THE INVENTION

According to an embodiment, there is a strain characterization system that includes a strain sensor having first and second electrodes that sandwich a dielectric layer to form a capacitor, a power source configured to inject a signal V_{AC} between the first and second electrodes of the strain sensor, and a controller configured to control the power source and to select a frequency of the power source. The controller is configured to select first to third different frequencies for determining a strain magnitude, a strain location, and an extent of a strain area.

According to another embodiment, there is a method for determining strain characteristics with a single strain sensor. The method includes applying a strain sensor to a target object, the strain sensor having first and second electrodes that sandwich a dielectric layer to form a capacitor, selecting with a controller a frequency of a signal V_{AC} to be injected into the strain sensor, applying the signal V_{AC} to the first and second electrodes of the strain sensor, with a power source, measuring a return signal from the strain sensor and determining a capacitance of the strain sensor, and estimating a strain magnitude, a strain location, and an extend of a strain area experienced by the strain sensor based on the return signal. Each of the strain magnitude, the strain location, and the extent of the strain area is measured at a different frequency.

According to yet another embodiment, there is a wireless strain sensor configured to measure a strain in a target, and the wireless strain sensor consists of: a dielectric substrate having a first part and a second part connected to each other through a strip third part, a coil formed on the first part, a first electrode formed on a first face of the second part, and a second electrode formed on a second face of the second part, opposite to the first face. Each of the first and second electrodes is configured to crack when the strain is present.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a strain sensor having electrodes that crack under strain;

FIG. 2 is an electrical schematic diagram for the strain sensor of FIG. 1;

FIG. 3 shows a system that includes the strain sensor of FIG. 1 and how an electromagnetic wave propagates through the electrodes of the strain sensors when cracks are present;

FIG. 4 shows voltage attenuation along the strain sensor as the strain in the sensor increases;

FIGS. 5A and 5B illustrate the relationship between the sensor capacitance and voltage dissipation, with FIG. 5A showing the influence of voltage dissipation on the measured capacitance at high frequency (500 KHz) and FIG. 5B showing the same at low frequency (10 KHz);

FIG. 6 illustrates the effective length L_{eff} versus strain, derived either from the capacitance measurements or voltage-disappearance;

FIG. 7 is a schematic of signal behavior in a saturation regime showing that the voltage dissipates only in the non-stretched zone and always dwells before the stretched zone;

FIGS. 8A and 8B show the change of the sensor capacitance versus frequency for a geometric regime, a transmission-line regime, and a saturation regime; the geometric regime is at low strain ε and frequency f (regime I), the transmission-line regime is at intermediate E and f (regime II), and the saturation regime is at high ε and f (regime III);

FIG. 9 shows the relative capacitance resulting from the geometric effect (length extension under stretching) versus strain in regime I; this mechanism appears only at low frequency (200 Hz in this test);

FIG. 10 shows the effective capacitances at ε=12% and f=500 kHz in each zone of the transmission line (the effective capacitance increases linearly with zone number i);

FIG. 11 is a schematic of a four-zone sensor with simultaneous local stretching in two zones j starting in zone i₀ (i₀=2, j=2);

FIGS. 12A to 12C illustrate the relationship between the extent of the stretching area and the effective capacitance of the sensor (effective capacitance in all possible cases of i₀ and j);

FIG. 13 is a flow chart indicating the measurement sequence and the information extractable by plotting capacitance measurements as a function of one of the g(f,R) parameters;

FIGS. 14A to 14D illustrate the accurate detection of finger-joint motions, showing the joints in the index finger in FIG. 14A, the strain magnitudes in joints 1 and 2 during four cycles of stretching and relaxing in FIG. 14B, and the identification of the bent joint from the capacity variation measured at high frequency in FIGS. 14C and 14D;

FIG. 15 is a flow chart of a method for measuring the strain intensity, strain location, and extent of the strain area with a single strain sensor in one sitting, by using only two leads attached to the strain sensor;

FIG. 16A shows a wireless strain sensor that communicates in a wireless manner with a portable device, FIG. 16B shows the various components of the wireless strain sensor and cracks formed in the electrodes of the strain sensor, and FIG. 16C is an electrical schematic of the wireless strain sensor;

FIG. 17 shows a cross-section through the wireless strain sensor and the various layers that form the first and second electrodes of the sensor;

FIGS. 18A and 18B show how the resistance of the electrodes of the strain sensor varies with the crack apparition under stress for various thicknesses of the electrodes;

FIG. 19 illustrates how the resistance of the strain sensor is substantially linear for a first strain regime and exponentially increasing for a second strain regime;

FIG. 20 illustrates a signal being injected into the strain sensor and a reflected signal having its frequency shifted after traveling through the strain sensor;

FIG. 21 illustrates how the capacitance of the strain sensor changes with the frequency for various strain values;

FIG. 22 shows a first implementation of the wireless strain sensor;

FIG. 23 shows a second implementation of the wireless strain sensor;

FIG. 24 shows how the first and second electrodes of the wireless strain sensor crack due to the strain; and

FIGS. 25A to 25C show a third implementation of the wireless strain sensor with a coil being separated from the capacitor type sensor and notches formed in the electrodes to control a crack density.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a capacitive sensor that uses fragmented carbon nanotubes (CNT) for the electrodes and applies a transmission-line model for calculating both the spatial coverage and the spatial resolution associated with the strain. However, the embodiments to be discussed next are not limited to CNT electrodes, but may be applied to other type of electrodes, for example, electrodes that include a combination of a rigid conductor and a brittle one.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a strain sensor uses a signal attenuation method to detect a local strain, by integrating electrodes with a changing resistance on parallel plate capacitors. This strain sensor is configured to detect strains in multiple zones along the sensor's body length, by using a transmission-line model. By integrating fragmented carbon nanotube (CNT) paper as electrodes, a soft parallel-plate capacitor with variable electrode resistance under strain is obtained. The electrode piezoresistivity helps to control the signal attenuation level of the sensor. Based on the voltage dissipation mechanism resulting from the electrodes' resistance variation, this strain sensor is capable to detect not only the local strain, but also other strain characteristics. Besides defining the sensing position, this strain sensor simultaneously (i.e., in the sitting) measures the strain magnitude and the extent of the strain-exposed region, thus ensuring enhanced strain detection. As discussed in later embodiments, this strain sensor detects accurate finger bending. This sensing technology with a reduced number of wires and a simple electronic interface will increase the reliability of sensing while reducing its cost and complexity.

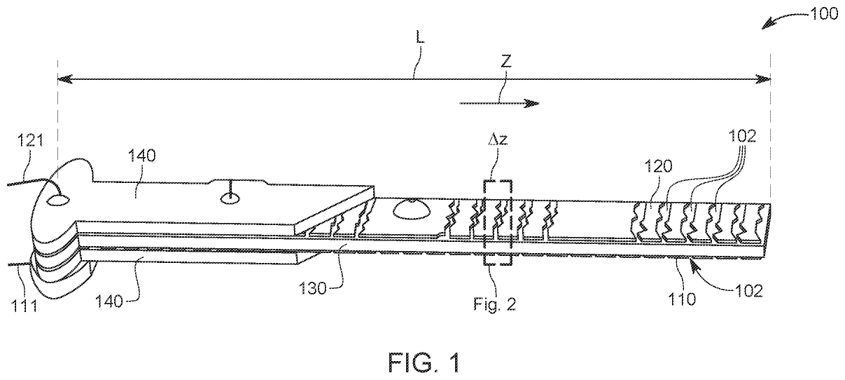

More specifically, as shown in FIG. 1, a distributed strain sensor 100 includes first and second electrodes 110 and 120 that sandwich a dielectric material 130. Both electrodes are made of a material that exhibits variable resistance. In this embodiment, the electrodes 110 and 120 are constructed from a single-walled CNT (SWCNT) paper that is initially non-stretchable (strain to failure less than 5%). The CNT electrodes are separated by the dielectric (DE) layer 130, which may be formed from poly(dimethylsiloxane) (PDMS). In one application, the entire sensor is embedded in a PDMS layer 140 (the figure shows the sensor only partially being embedded in the PDMS sensor for better viewing the electrodes 110 and 120) to avoid delamination of the CNT papers from the DE layer.

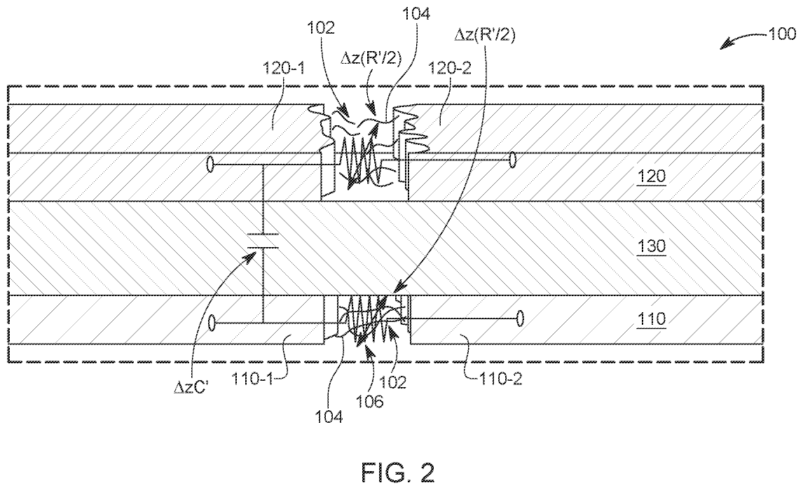

When stretched, the multilayer sensor 100 develops periodic channel-like cracks 102, which are substantially perpendicular to the principal loading direction (z direction in FIG. 1) of the sensor. FIG. 2 shows a partial cross-section through the sensor 100 and illustrates a crack 102 that partially separates a first part 110-1 of the first electrode 100 from a second part 110-2. The same is true for the second electrode 120, i.e., a first part 120-1 is partially separated from a second part 120-2 by the crack. Note that these parts do not fully separate from each other as there is always some electrical connection between them (for example, carbon nanotubes). Due to the crack 102, an increased resistance R′ is generated. Thus, each crack generates an additional resistance R′. Note that each crack completely separates at least two continuous parts of one of the two electrodes. FIG. 1 schematically shows plural cracks formed in each of the first and second electrodes. In one application, it is possible that only one electrode is configured to develop cracks.

After unloading, the crack opening displacement is reduced via a relaxation processes in the dielectric layer 130 as the material of the dielectric layer is selected to be flexible and regain its initial length. The entangled SWCNT 104 form a network 106 that bridges the parts 110-1 and 110-2 and also parts 120-1 and 120-2, within the cracks (allowing electron transport between the CNT fragments) and thus, the electrode's resistance is increasing upon stretching. The high resistivity of the electrodes that appear after crack opening induces the transmission-line behavior in the entire sensor 100 at radio frequencies.

Returning to FIG. 1, each electrode 110 and 120 is electrically connected to a corresponding single lead 111 and 121, respectively. Note that a length L of the sensor may be in the range of mm to cm to even dm, so that a large spatial coverage of the strain can be detected. FIG. 1 also shows that for such a large sensor, only two leads are necessary, i.e., the amount of wiring for detecting the spatial coverage of the strain is substantially reduced. Although the length L of the sensor 100 may be in the order of cm or tens of cm, this sensor is able to determine where the strain starts and the extent of the strain area.

FIG. 1 further shows that the plural cracks 102 may form a pattern, i.e., a distance between any two adjacent cracks may be a constant. To obtain this cracking pattern of the electrode, it is possible to form crack initiators (e.g., initial cuts or notches into the side of the electrode) into the electrode so that when the electrode is stretched, the crack initiators trigger the location of the cracks. A crack initiator does not necessarily separate an electrode into two distinct parts, as shown in FIG. 2. A crack initiator only alters the structure of the electrode at a desired location but does not have to extend all the way through the electrode. The crack initiators may be made with a laser, with a mechanical device, or chemically. When the sensor is loaded, i.e., strain due to the forces present on the target on which the sensor is located, the dielectric layer 130 and the coating 140 do not crack as they are made of flexible materials. Only the first and/or second electrodes exhibit the cracks during the strain phase due to their composition.

The sensitivity of a capacitive strain sensor was improved in previous work by the inventors by using the transmission line model [5]. However, that work did not study the capability of calculating both the spatial coverage and the spatial resolution associated with the strain experienced by a given target. Applying the transmission line model, the electrical model of the transmission line sensor can be represented by a chain of R-C circuits rather than a simple capacitive element, as schematically illustrated in FIG. 2. Because of the presence of a series of cracks 102 in the electrodes 110 and/or 120, the sensor 100 is modeled as a series of small segments (Δz), each represented by a capacitance ΔzC′ and a variable resistance ΔzR′, where C′ and R′ are the specific capacitance and the specific resistance, respectively.

A method for accurately sensing strain using the transmission-line capacitance, which is affected by signal penetration along the sensor length, is now discussed. Initially, the dissipation behavior of the electrical signals along the sensor's length is investigated. Through electromechanical measurements, the interaction between the electrode resistance and sensor capacitance under a mechanical load is observed. The resistance R of the fragmented electrodes alone increased exponentially with an increase in the stretching extent of the sensor. When cracks appeared in the conductive CNT papers, the piezoresistivity of the electrodes greatly increased. Various resistances can be achieved by increasing the number of cracks per unit length. Thus, the crack density in the sensor 100 can be controlled by patterning the pre-cracks (crack initiators) under mechanical loading. Because the electrodes are inherently resistive, the capacitance of the sensor behaves as a transmission line at certain strains and frequencies. This capacitance behavior refers to the voltage dissipation in the structure.

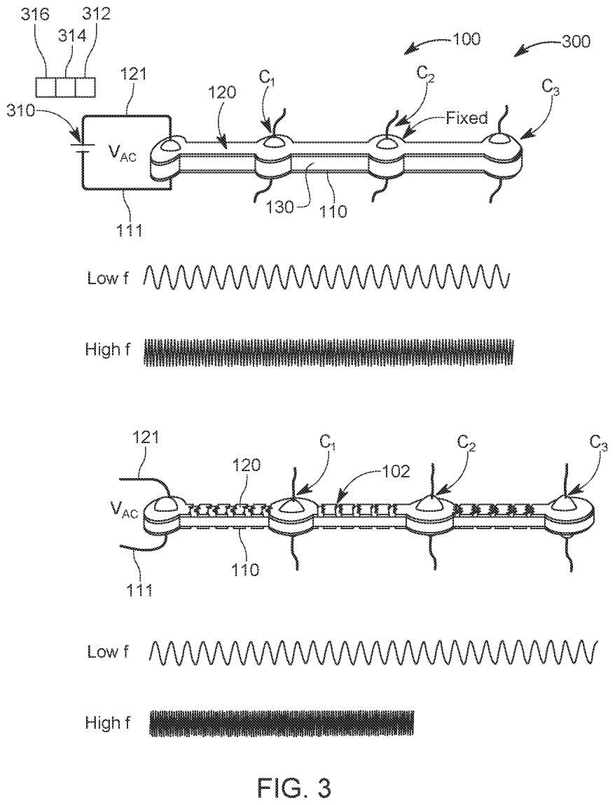

The voltage dissipation was experimentally measured at four electrical connections 111/121 and C1 to C3, which are evenly distributed along the sensor 100's length, e.g., at 10-mm intervals, as illustrated in FIG. 3. Note that the final structure of the sensor 100 has neither the contacts C1 to C3, nor the shapes of the contacts as shown in the figure, only the leads 111 and 121. In other words, the contacts C1 to C3 are added to the sensor 100 only for the purpose of demonstrating the method used to determine the spatial resolution and coverage of the strain sensor, and these contacts are not present in the final design of the sensor.

An input signal V_{AC} was injected at the origin (contact point 111/121) of the sensor 100. In a real case implementation of the strain detection system 300, this voltage may be supplied by a power source 310, for example, a battery, a specialized power source, or by a smart device, e.g., a smartphone, which have the capability to supply and/or generate and/or help to generate a high frequency signal. Its magnitude is V₀=1.0 V, and its frequency is high (500 kHz). One skilled in the art would understand that these values may vary by +/−10 to 20% and still achieving the desired results. To avoid small voltages near the measurement limit, it is assumed that the effective length of the sensor was reached when the voltage reached a minimum magnitude Vₘᵢₙ, arbitrarily set to 0.1 V₀. In one application, the system 300 may also include a controller 312 (e.g., processor and memory) to adjust the frequency of the power source as required. Note that the output of the power source is an AC current defined by the amplitude V₀ and a frequency f. The controller may also process the collected data (i.e., reflected signal) for determining the various strain characteristics. The controller 312 may be attached to a display 314 for displaying the strain characteristics. Instead of the display 314, or in addition to such a display, the system 300 may also include a transceiver 316 for communicating in a wireless manner with a server (not shown). The system 300, which also includes the sensor 100 and its leads, is portable in this embodiment, i.e., it can be moved to any desired target for strain characterization.

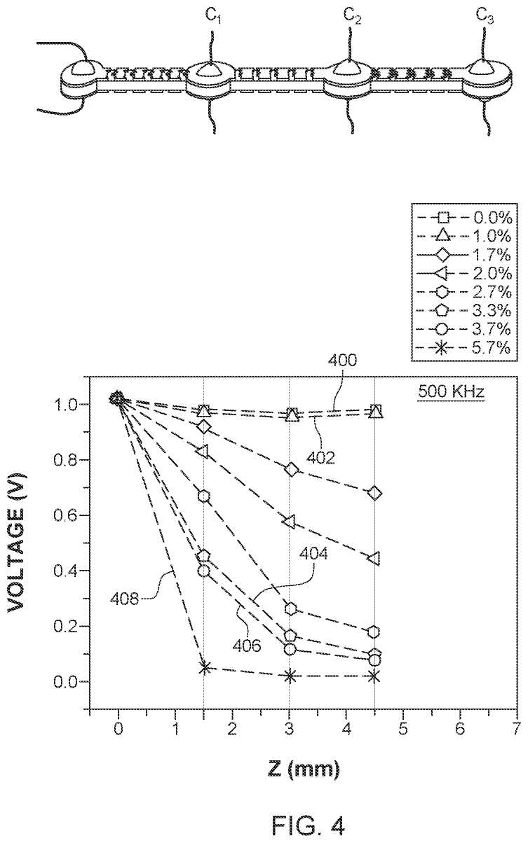

FIG. 4 shows the voltage attenuation along the sensor's length as a function of strain. Under low strains, the signal magnitude was retained along the sensor length as indicated by curve 400. This is also illustrated in FIG. 3, were both the low and high frequency signals propagate to the end of the sensor. When the strain reached a value of 1%, the increase in electrode resistance became noticeable and the signal was attenuated at some distance from the origin point (see curve 402). This is also illustrated in FIG. 3, where the low frequency signal propagates to the end of the sensor while the high frequency signal does not. The signal disappeared from contacts C3 (z=L), C2 (z=2L/3), and C1 (z=L/3) when the strained reached a value of 3.3%, 3.7%, and 5.7%, respectively (see curves 404, 406, and 408 in FIG. 4). The voltage profile was directly related to the strain and decreased progressively as the strain increased.

These results may be analytically interpreted based on the transmission-line characteristics to determine the strain intensity, location, and strain extent. More specifically, the voltage attenuation along the transmission line (i.e., sensor 100's length) can be defined by the telegraph equation, which is:

$$V ( z ) = {V}_{0} {e}^{- \sqrt{π {fR}^{′} {C}^{′}} z} , \qquad ( 1 )$$

where V₀ is the magnitude of the alternative input voltage that is applied at the leads 111/121, and the exponent of the exponential part of the equation corresponds to the attenuation factor α=\sqrt{πfR′C′} of the voltage along the length of the sensor. In this expression, f is the frequency of the interrogation signal and C′ and R′ are the specific capacitance and resistance, respectively (i.e., capacitance and resistance per unit length) of the sensor. The voltage dissipation phenomena change the effective sensor's length, which is represented by the distance from the origin (location 111/121 where the voltage is applied) to the point where the signal is fully attenuated. This effective length (L_{eff}) was analytically derived in the inventors' previous work [5], which introduced an additional term g(f,ε) to the L_{eff} equation:

$${L}_{eff} = L \times g ( f , R ( ε ) ) = {L}_{0} ( 1 + ε ) g ( f , R ( ε ) . \qquad ( 2 )$$

In equation (2), L and L₀ are the stretched and initial lengths, respectively, of the sensor 100, ε is the applied strain, f is the signal frequency, and R(ε) is the strain-related electrode resistance. Note that while L and L₀ are actual lengths of the sensor under various conditions (e.g., strain), the effective length L_{eff} is a length that is “seen” by the applied electrical signal due to the voltage V₀. The value of the term g(f, R) ranges from 0 to 1, depending on the transmission-line model. This term was determined in [5] to be given by:

$$g ( f , R ) = \frac{- ln ( \frac{{V}_{min}}{{V}_{0}} )}{\sqrt{π f C R}} , \qquad ( 3 )$$

where V₀ is the magnitude of the input voltage, Vₘᵢₙ is the voltage at which the transmission line becomes ineffective (the “nonexistent” voltage), C is the sensor capacitance, and R is the electrode resistance.

Exploiting the linear relation between the sensor's length and capacitance, the effective capacitance C_{eff} was obtained to be

$${C}_{eff} = {C}_{0} ( 1 + ε ) g ( f , R ( ε ) ) , \qquad ( 4 )$$

where C₀ is the initial capacitance of the sensor before stretching, (1+ε) is the change in capacitance due to pure geometrical effects, which depends on the linear expansion of the sensor's length L under strain, and g(f,ε) represents the transmission line effect. The effective capacitance C_{eff} corresponds to the effective length L_{eff} of the sensor. The transmission line effect factor becomes influential when (g(f,R)<1), i.e., when f, R, or both are high, thus decreasing the capacitance of the sensor.

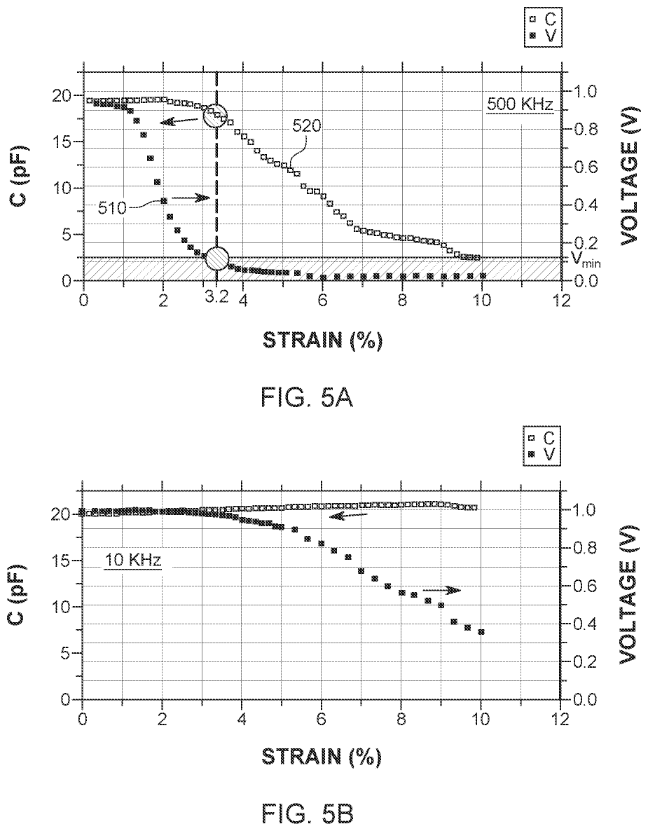

FIG. 5A shows the voltage measured at contact C3 at 500 KHz (that represents an example of a high-frequency regime), i.e., at the extremity of the sensor 100. The voltage 510 decreases to Vₘᵢₙ (meaning that the signal does not reach the end of the sensor anymore) when the stretch increases, and the effective capacitance 520 began to decrease. This change in the working regime appears around 3.2% strain, after which L_{eff} drops below L, which is the original length of the sensor 100. As expected, this behavior was absent at low interrogation frequencies. When the interrogation signal frequency was 10 kHz, the voltage attenuated but never decreased to Vₘᵢₙ; thus, the effective capacitance remained almost constant over the entire strain-loading range, as shown in FIG. 5B.

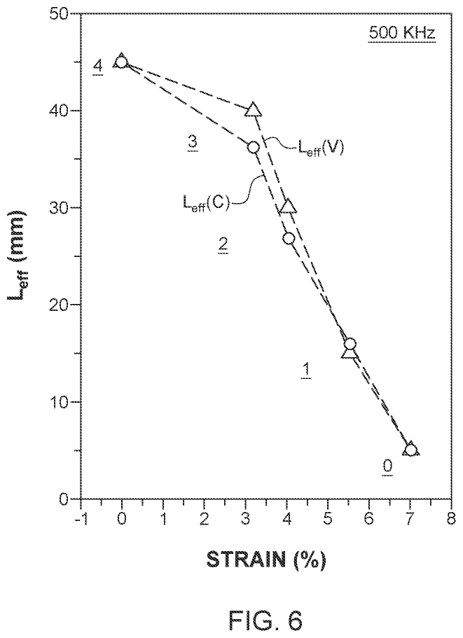

To further confirm that the voltage attenuation is indeed the source of the capacitance change, the inventors first introduce a capacitance-based effective length by calculating L_{eff} (C) as a function of the measured capacitance C:

$${L}_{eff} ( C ) = \frac{C {d}_{0}}{{e}_{0} {e}_{r} {ω}_{0}} , \qquad ( 5 )$$

where e₀ and eᵣ are the vacuum permittivity and dielectric constant of the dielectric layer, respectively, and wo and do are the initial width and thickness (distance between both electrodes) of the dielectric layer, respectively. Next, the inventors also introduce a voltage-based effective length L_{eff} (V), which is defined as the length between the injection point and the location at which the voltages reaches Vₘᵢₙ. FIG. 6 confirms a strong match between L_{eff} (V) and L_{eff} (C), meaning that the measured capacitance is closely related to the voltage attenuation and, therefore, to the electrode resistance.

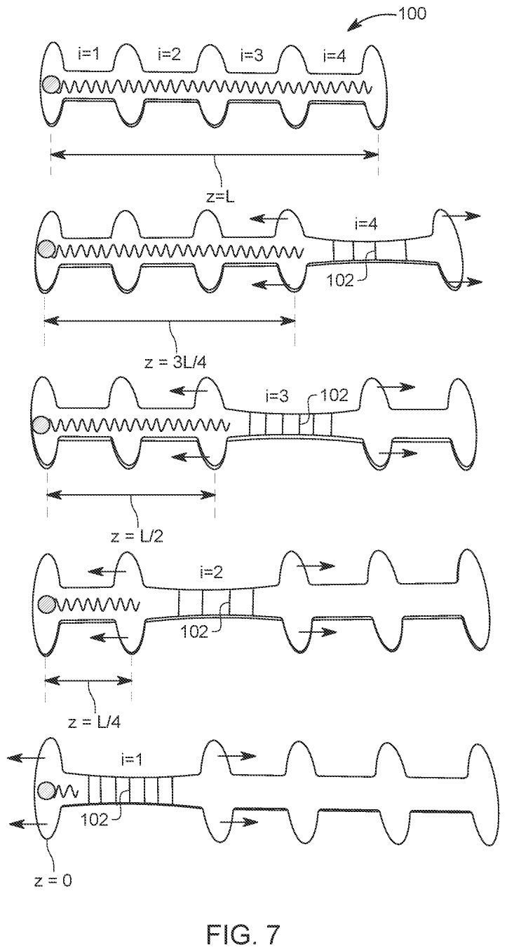

As the effective length of the sensor 100 can be controlled by applying an external strain, the inventors have discovered that it can potentially realize distributed strain detection as now discussed. Thus, the above-identified mechanism, in which the effective length changes with frequency or strain amplitude, is applied to estimate the distributed strain sensing. For the following discussion, the sensor 100 has been modeled to include four stretchable zones, as shown in FIG. 7, each zone being distinguished by an index i (1≤i≤4). FIG. 7 shows the sensor 100 being initially unstrained, and then a strain is applied to the fourth region, then to the third one, then to the second one, and finally to the first one.

The g(f,R) factor representing the transmission-line mechanism is used for identifying the strain distribution according to this method. As shown in equation (3), the factor g(f,R) is close to 1.0 when the product f×ε is low (note that the electrode resistance is low under small strains and increases at higher strains). This product is low when the frequency of the injected signal is smaller than 1.5 kHz and/or the strain is smaller than 2.5%. In this case, the influence of the transmission line is absent and the capacitance is determined only by the well-known geometrical effect. Accordingly, equation (4) is reduced to C_{eff}=C₀(1+ε). At an intermediate f and ε (e.g., frequency between 1.5 k and 45 KHZ and/or strain between 2.5 and 8%), the factor g(f,R) begins decreasing (g<1.0) as the transmission-line phenomena began to dominate and the capacitance starts to decrease. At very high f×ε (e.g., frequency larger than 45 kHz and/or strain larger than 8%), the factor g(f,R) is very small and the capacitance is saturated at some minimum value.

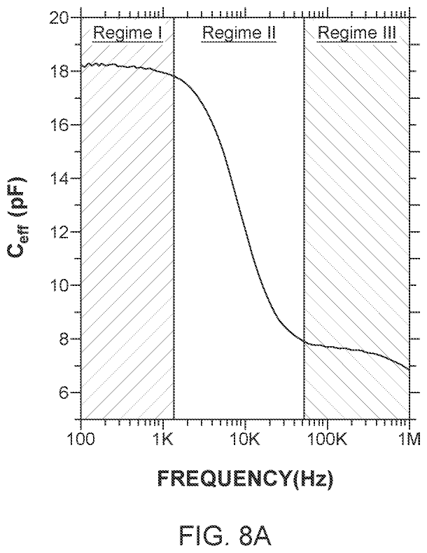

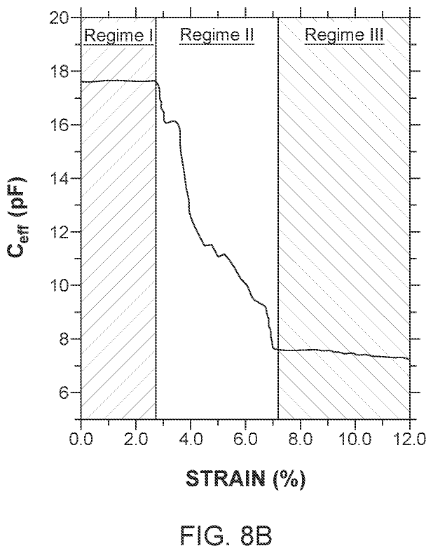

Based on the above analysis, the inventors have split the capacitance variation of the sensor into three independent regimes: the geometric regime (or regime I), the transmission-line regime (or regime II), and the saturation regime (or regime III). FIG. 8A plots the capacitance variation over the three regimes as a function of the frequency while FIG. 8B plots the capacitance variation over the three regimes as a function of the strain. Here, the geometric regime is defined from the beginning of the measurement until the beginning of the capacitance decline (low for ε). Within the attenuation regime (f=1.5-45 kHz, ε=2.8%-8.0%), the capacitance decreased from its maximum to its minimum value. Finally, the saturated regime began when the capacitance did not further decrease and became independent of both strain and frequency.

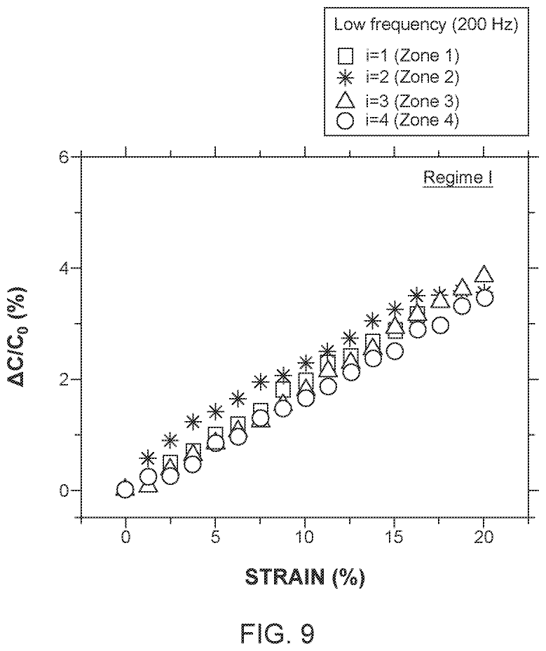

Thus, based on this information, the strain intensity (strain magnitude) can be determined from the capacitance variation in regime I. FIG. 9 plots the relative capacitance under gradual strain in the four zones (i=1-4) shown in FIG. 7, at a very low frequency (about 200 Hz). It is noted that the capacitance linearly increased with the local length extension (ΔIᵢ) in each zone, reflecting the dominant geometric effect. The relative capacitance versus length relationships were identical, and their slopes were about 0.2 for all zones. The sensitivity was low because the strain was applied to part of the sensor, whereas the capacitance was measured over the entire sensor (i.e., the gauge factor (GF) was divided by the total zone number n). Thus, by using the curves shown in FIG. 9, which may be stored in the controller 312 associated with the sensor 100, it is possible to measure the variation of the capacitance of the sensor when under strain and to calculate the corresponding strain intensity (from the curves in FIG. 9). Therefore, the strain intensity is determined with a low frequency signal (e.g., below 1,500 Hz). As discussed above, the capacitance under a local strain in regime I (C_{I}) depends on the total zone number n. More specifically, the new capacitance is inversely proportional to n, implying that dividing the transmission line into many zones impairs the sensor's sensitivity.

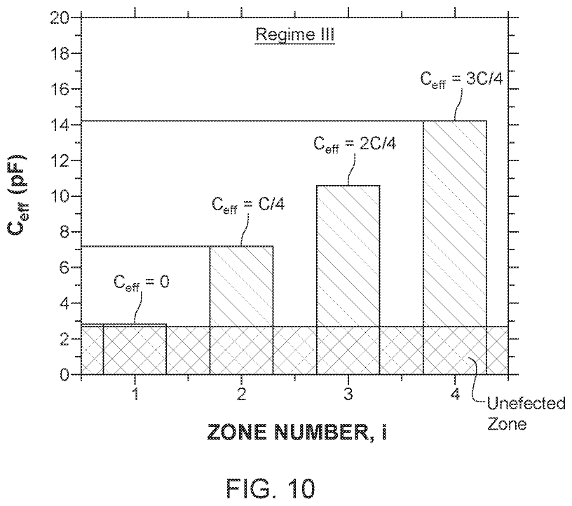

Meanwhile, the strain distribution (strain location) can be determined in regime III (when the factor g(f,R) is minimal and constant). FIG. 10 shows the total effective capacitance in each zone (i) at f=500 KHz (high frequency) and strain ¿=12%. In stretching zone 1 (i=1), the capacitance drop toward the minimum value (2.5 pF) was large and further stretching led to a different result from that in stretching zone 4 (i=4). In stretching zone 4, the capacitance drop was small and the effective capacitance remained at ¾ of the initial C value.

Thus, the controller 312 discussed above, which is associated with the sensor 100, may instruct the power source 310 to change the frequency of the applied voltage so that the sensor operates in the regime III. Based on the measured capacitance in this regime, and using the data noted in FIG. 10, the controller 312 is capable to determine which zone number i is stretched, i.e., to identify at which location along the sensor (see FIG. 7) the strain is applied. For example, for the calculated value of the C_{eff}, the controller determines that i=3, then, the controller is able to infer that zone 3 in FIG. 7 is strained and thus, it knows precisely enough where the strain starts. However, with this information it is not known the geographical extent of the strain on the sensor 100.

The capacitance saturation (regime III) refers to the signal behavior inside the sensor 100 after applying a local strain (stretching one zone), as shown in FIG. 7. The signal easily crossed the nonstretched zones as the low electrode resistance ensured no dissipation. However, when the signal reached the high-resistance stretched zone (where the cracks 102 are present), it dissipated and eventually faded completely (note that FIG. 7 shows a wiggly line where the signal still propagates inside the sensor 100, and lack of the wiggly line indicates no signal is propagating at that location). At high ε and f (i.e., regime III), the signal disappeared within the stretching zone and was absent thereafter; thus, the effective length of the sensor corresponds to the length of all unstretched zones before reaching the area that experiences saturation. For example, when zone 3 was stretched, the electrical signal passed through the first and second zones without resistance and was stopped at the beginning of zone 3. Generalizing this case, the inventors deduced the zone-dependent effective length L_{eff} (i) and the effective capacitance C_{eff} (i), respectively, as follows:

$${L}_{eff} ( i ) = \frac{( i - 1 )}{n} L ; {C}_{eff} ( i ) = \frac{( i - 1 )}{n} {C}_{0} ( 1 + \frac{ε}{n} ) . \qquad ( 6 )$$

Note that the above-defined L_{eff} and C_{eff} concern only the effective length and effective capacitance, respectively, of the sensor 100 in regime III. These analytical equations are highly consistent with the experimental result shown in FIG. 10, in which the total sensor capacitance depends on the number (i) of the stretched zone.

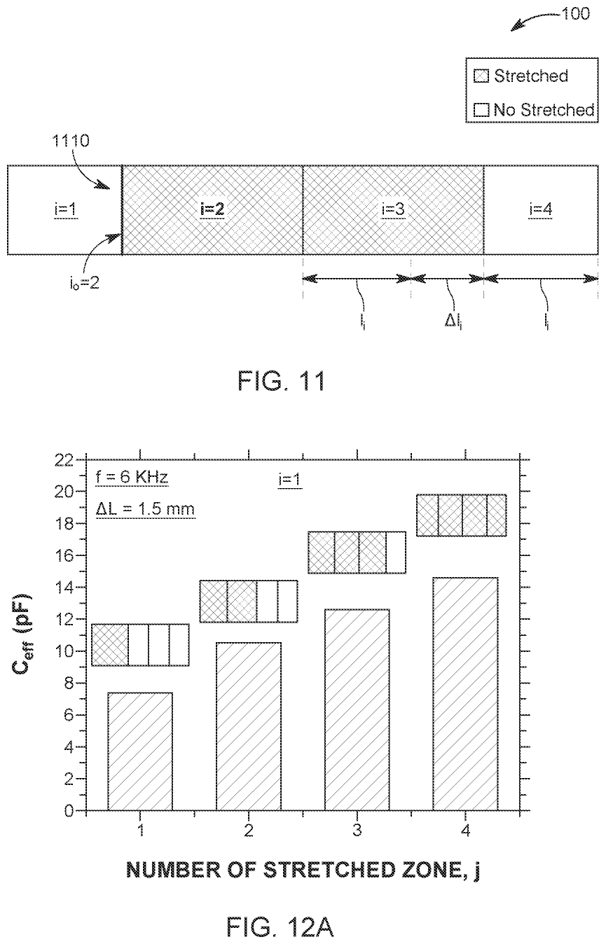

Thus, the information in the regime Ill is useful for detecting the beginning of the stretched zone, but the extent of this zone cannot be determined based on this data because the signal is fully attenuated at that point. Instead, the extent of the stretched area can be inferred from the number of stretched zones (referred herein to as j) in the transmission-line regime (i.e., in regime II). FIG. 11A schematically illustrates the sensor 100 having four-zones (1<i<4) with zones 2 and 3 (i=2, 3) stretched. In this example, j=2 and the starting point i₀ is also 2.

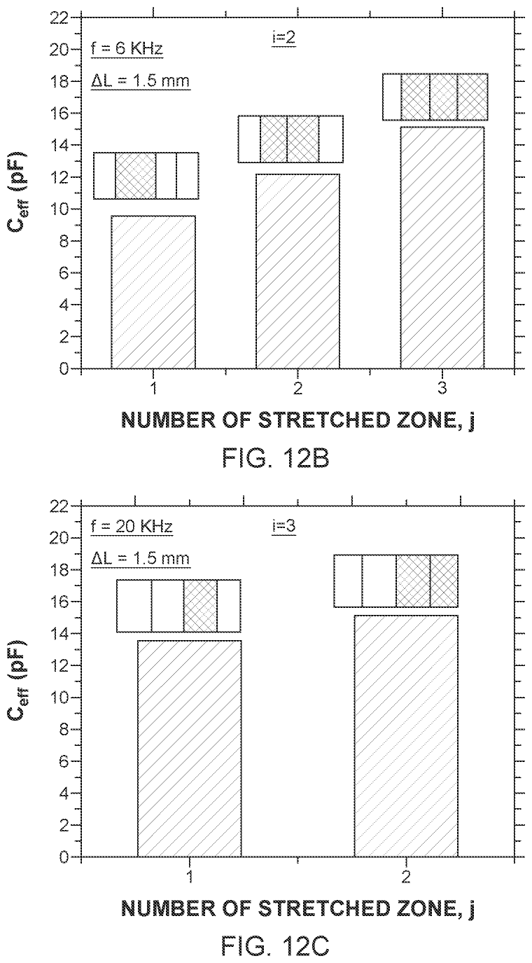

The attenuation speed and j can be related to each other through the capacitance. When the capacitance of the global sensor is plotted as a function of the two influencing terms (f and R) for different values of j, with a fixed starting zone (here, i₀=2), the attenuation slope of the capacitance decreased with j. When one zone was stretched (j=1), the minimum capacitance was obtained more quickly than when additional zones were stretched (j>1). From these measurements, the inventors obtained the effective capacitance as a function of the number of strained zones j for different starting points (i₀) at a fixed frequency (f=6 or 20 kHz) and extension (1.5 mm), as shown in FIGS. 12A to 12C. Thus, based on these measurements, it is possible to calculate/estimate the value of j, i.e., how many zones are stretched, which provides the strain extent in the sensor 100. The results confirmed a direct relationship between C_{eff} and the extent of the stretching area of the sensor; in particular, the effective capacitance value increased with increasing j. It is noted that the starting zone (i₀) defining the beginning of the stretching zone (line 1110 in FIG. 11) can be determined from the size of the unaffected area or the minimum capacitance in regime III as discussed above.

When part of the strain sensor is strained, the difference in the degree of capacitance/voltage attenuation refers to the nonuniform resistance distribution over the electrodes. The electrode resistance is negligible in the nonstretched zones compared to that in the stretched zones; therefore, only the stretched length contributes to the global electrode resistance R, which produces

$${R}^{′} = \frac{R}{jL / n} .$$

Referring to equation (1), the attenuation of the traveling voltage wave along the multiple stretched zones along the sensor's length is affected by j. This behavior is reflected in the effective capacitance of a partially stretched sensor C_{eff,j}, which is proportional to

$$j ( {C}_{eff , j} = {C}_{eff} \sqrt{\frac{j}{n}} ) .$$

According to this equation, C_{eff,j} can be changed merely by changing the area of the stretching zone j. From this relation between C_{eff,j} and j, the controller 312 can determine/estimate the extent of the stretching area. The voltage attenuation slope was inversely proportional to the number of stretched zones j, meaning that the voltage disappeared more slowly as the strained length increased. On the contrary, the capacitance should increase with increasing j (as C_{eff,j}˜\sqrt{j}). This capacitance behavior is verified by the experimental results shown in FIGS. 12A to 12C.

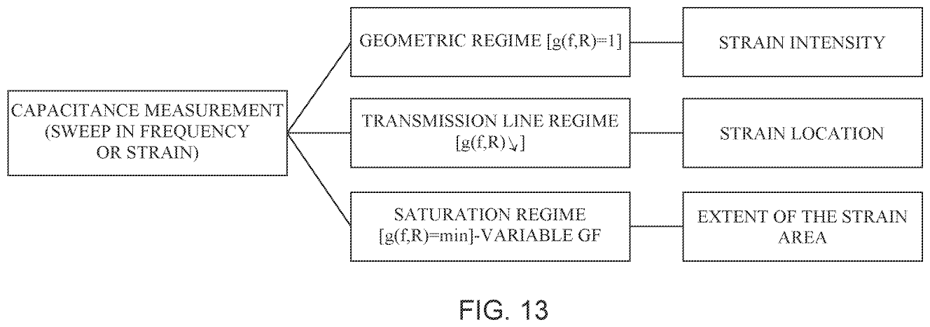

Thus, the three regimes shown in FIGS. 8A and 8B can be used to program the controller 312 to determine, during a single measurement session (i.e., one sitting), as schematically illustrated in FIG. 13, the strain magnitude/intensity (based on the geometric regime, when the factor g(f,R) is equal to 1), strain location (based on the transmission line regime, when the factor g(f,R) is decreasing), and the extent of the stretched area (based on the saturation regime, when the factor g(f,R) is at its minimum) by measuring the sensor capacitance and choosing the appropriate frequency for each regime. The three pieces of information simultaneously acquired by the single sensor 100 enhance the sensor's ability to obtain accurate strain information.

A method for making the sensor 100 is now discussed. The SWCNT papers were fabricated from SWCNTs doped with 2.7% COOH groups. The SWCNTs were more than 90-wt % pure and contained more than 5-wt % multiwalled CNTs. Their outer diameters and lengths ranged from 1 to 2 nm and from 5 to 30 μm, respectively. The CNTs were dispersed in methanesulfonic acid (CH₃SO₃H), and the stretchable dielectric material was PDMS. The electrical wires were affixed to the structure using a conductive adhesive (e.g., silver conductive epoxy).

The CNT paper was developed using the filtration method. First, the SWCNTs (0.5 wt %) were dissolved in CH₃SO₃H to create a liquid solvent. The SWCNT/CH₃SO₃H solvent was sonicated for 60 min. The mixture was re-stirred for 12 h at 500 rpm. A 40-g volume of the solvent dispersion was vacuum-filtered through a sintered glass filter disc of diameter 120 mm. This low-porosity filter disk prevents passage of the CNTs. The SWCNTs left on the filter were washed with 200 ml of water to remove any remaining CH₃SO₃H. After 5 h in a vacuum, a free-standing SWCNT paper of diameter 80 mm and thickness of 50-100 μm was obtained.

The parallel-plate capacitor that constitutes the base of the sensor 100 includes two conductive layers (electrodes) separated by an insulating layer (dielectric material). The capacitive strain sensor 100 is a parallel-plate capacitor prepared by sandwiching a PDMS layer between two CNT layers and covering both CNT sides with PDMS layers. In one embodiment, the SWCNT paper was cut using a laser-cutting machine into a repetitive pattern of (10×5) mm² rectangular strips. The PDMS was prepared by treating a mixture of curing agent and PDMS monomers (mass ratio of 1:10) in a vacuum oven (approximately −0.94 bar) to remove air bubbles. The first strips of the laser-engraved SWCNT paper were transferred to a half-cured, 0.5-mm-thick PDMS substrate to form the bottom electrodes. A second PDMS layer precursor of equal weight was then poured onto the two existing layers. The CNT-paper integration was repeated to produce the top electrode and its electrical connections. A third PDMS was deposited onto the previous layers to fully encapsulate the SWCNT papers. Each PDMS layer was cured at 70° C. in an oven for 2 h. The superposed layers were cut using a laser-cutting machine, finally yielding an encapsulated parallel-plate capacitor with electrical connections as shown in FIG. 1.

The tests discussed in the above embodiments for measuring the voltage dissipation along the sensor length were performed with an AC voltage source and the voltage was measured at the other locations. The capacitance was deduced from the voltage and current measurements obtained using an LCR meter. Besides enabling capacitance measurements, the LCR meter can inject a signal with controlled frequency and amplitude into the sensor. The voltage residue along the sensor length and the electrode resistance were measured using a digital multimeter. The length variation ΔL in the sensor 100 under stretching was experimentally measured and the strain ε was then calculated as

$$ε = \frac{Δ L}{{L}_{0}} ,$$

where L₀ is the initial sensor length.

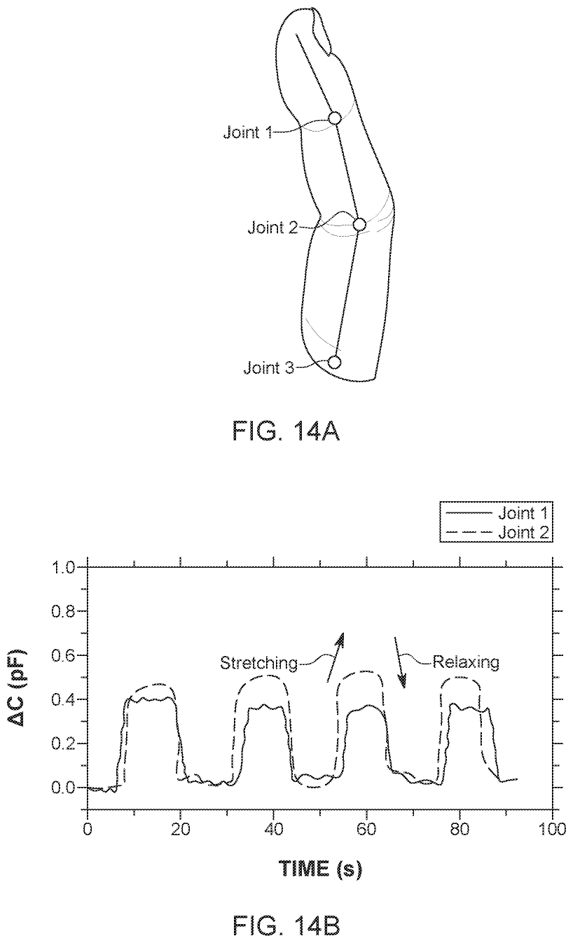

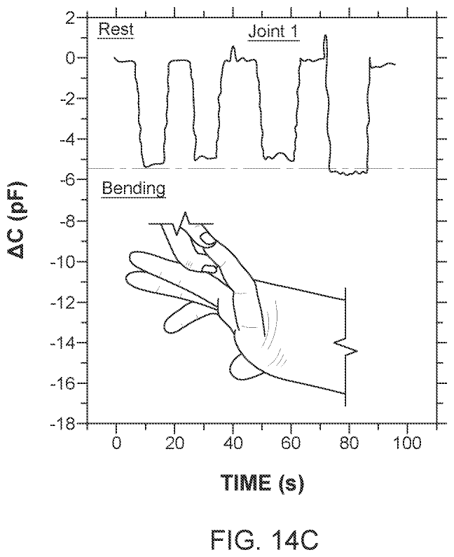

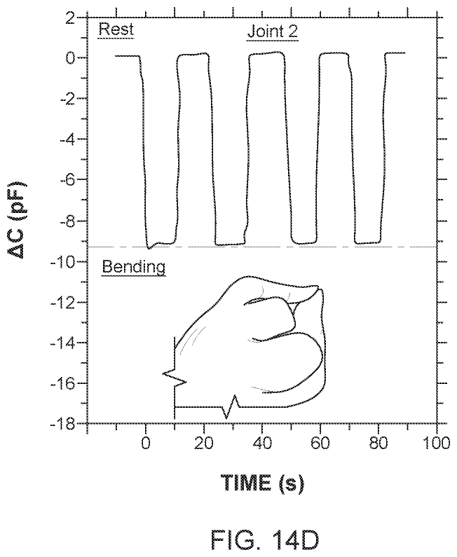

Sensor 100 was used in an accurate strain-sensing application as now discussed. Accurate measurements of hand motions are essential for active human interactions with a virtual environment. Some of the expected future sensing applications, i.e., translating sign language into speech and text, turning the hand into a gaming controller, and identifying objects, require a highly accurate glove that covers the entire hand. The hand is a complex structure with many degrees of freedom and numerous articulated joints. In this regard, FIG. 14A schematically illustrates joints 1-3 in the index finger. An increasing number of smart gloves with individual or array sensors are being developed for this purpose; these can be stretched to fit the finger joints and obtain accurate finger-motion measurement. However, in the existing systems, each finger requires at least three individual sensors with six cables and a complicated electronic interface, which hinders the hand movement. The single one-sheet sensor 100 covers a full finger and accurately detects finger-joint motions using a minimum number of cables (only 2) and rigid electronics. The strain magnitude was detectable under low-frequency operation (1 kHz), as illustrated in FIG. 14B, during which the capacitance increased by 0.4 pF upon bending any joint of the index finger. Meanwhile, by measuring the capacitance variation at a high frequency (2 MHZ), the controller 312 could identify which joint was bent. As shown in FIGS. 14C and 14D, the capacitance decreased by 5.2 pF upon bending joint 1 and by 9.5 pF upon bending joint 2. These tests indicate that, as discussed with regard to FIG. 13, it is possible to use the single sensor 100, which has only two leads, and simultaneously detect the strain intensity, strain location, and the extent of the strain area of a target object on which the sensor is placed. Note that the sensor 100 is made as a single piece of equipment, with no plural sensor embedded into it.

Thus, the above embodiments indicate that a soft capacitive sensor that can collect accurate strain information from deformable systems with a minimum number of leads is possible. Unlike conventional sensors that collect only one type of information, the single-sensor sheet 100 can simultaneously measure the strain magnitude, strain location, and strain area. The term “simultaneously” is understood here to mean during one “sitting of the sensor on the target object,” and not necessarily at the same time instant. As the frequency of the signal that measures each of these features needs to be changed, the sensor requires a finite amount of time to detect all three strain characteristics. The sensor is a soft parallel-plate capacitor with one or two cracked electrodes (CNT papers) separated by a dielectric layer (PDMS). Under an increasing mechanical load, the cracks developed in the CNT paper cause an exponential change in the electrode resistance. The variable electrode resistance induces voltage dissipation through the structural length under high-frequency operation; thus, the sensor can be considered as a transmission line. Exploiting the transmission-line properties of this model, the relationship between voltage dissipation and capacitance can be exploited for determining the strain characteristics discussed with regard to FIG. 13. As only the part carrying the signal can be observed by the measuring instrument, the measured capacitance depends on the signal's length. Combining the geometrical model with the transmission line mechanism, the inventors confirmed that sensor 100 detects the distribution and area coverage of strains in deformable systems, such as human motions and industrial structures, with a minimal number of individual sensors. The sensor 100 provides an alternative solution to array systems, which require a complex connection of many interfaces. Therefore, sensor 100 allows freer movements of the target deformable systems than the conventional array sensors.

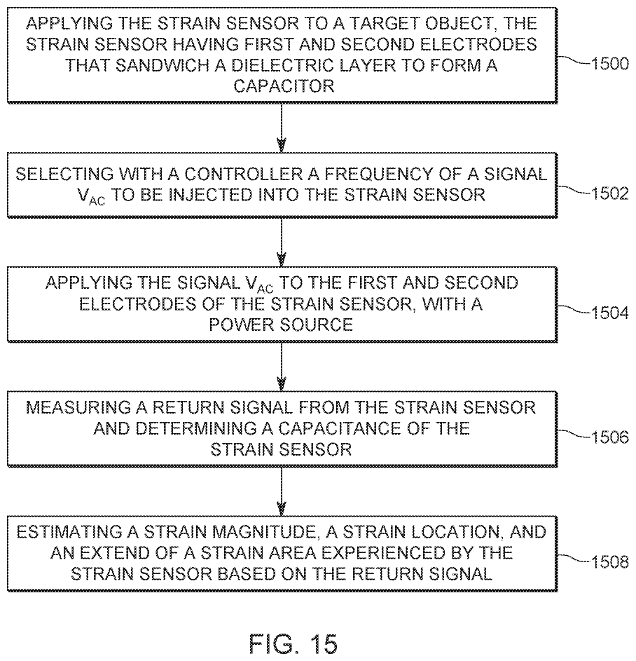

A method for determining strain characteristics with the single strain sensor discussed above is now presented with regard to FIG. 15. The method includes a step 1500 of applying the strain sensor to a target object, the strain sensor having first and second electrodes that sandwich a dielectric layer to form a capacitor, a step 1502 of selecting with a controller a frequency of a signal V_{AC} to be injected into the strain sensor, a step 1504 of applying the signal V_{AC} to the first and second electrodes of the strain sensor, with a power source, a step 1506 of measuring a return signal from the strain sensor and determining a capacitance of the strain sensor, and a step 1508 of estimating a strain magnitude, a strain location, and an extend of a strain area experienced by the strain sensor based on the return signal. Each of the strain magnitude, the strain location, and the extent of the strain area is measured with a different frequency.

In one application, the strain magnitude, the strain location, and the extent of the strain area are measured with the same first and second electrodes. The controller is configured to select, the first frequency in a first frequency range, to determine the strain magnitude based on a first response of the strain sensor, the second frequency in a second frequency range, different from the first frequency range, to determine the strain location based on a second response of the strain sensor, and the third frequency in a third frequency range, different from the first and second frequency ranges, to determine the extent of a strain area based on a third response of the strain sensor. In one application, the first frequency range is between 100 Hz and 1.5 kHz, the second frequency range is between 1.5 kHz and 45 kHz, and the third frequency range is between 45 kHz and 1 MHz.

The method may further include calculating a capacitance of the strain sensor for each of the first to third frequencies, and determining the strain magnitude, the strain location, and the extent of the strain area based on the calculated capacitances. At least one of the first and second electrodes is configured to crack when a strain is applied to the strain sensor. In one application, cracks are formed periodically in the at least one of the first and second electrodes, wherein the cracks increase a resistance of the first and second electrodes and make a transmission line model applicable to the first and second electrodes, and wherein the first and second electrodes include carbon nanotubes and the dielectric layer is flexible, so that after the strain is removed, cracks that appear in the first and second electrodes disappear as the dielectric material contracts the first and second electrodes.

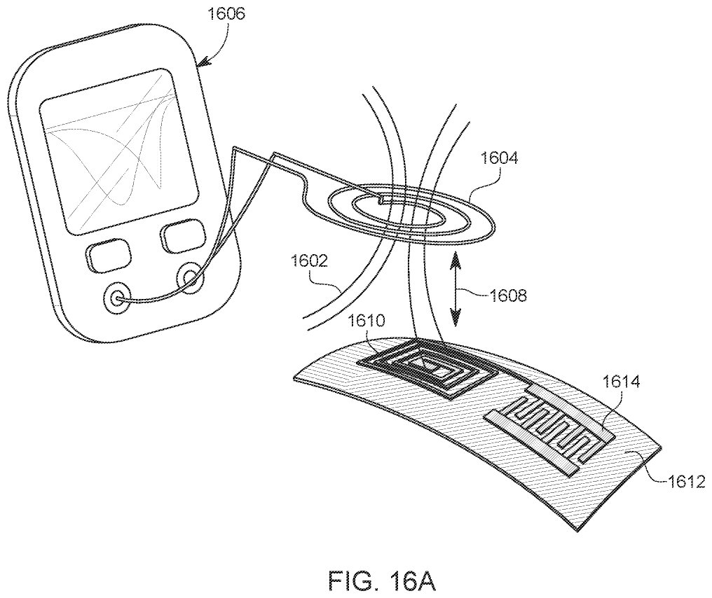

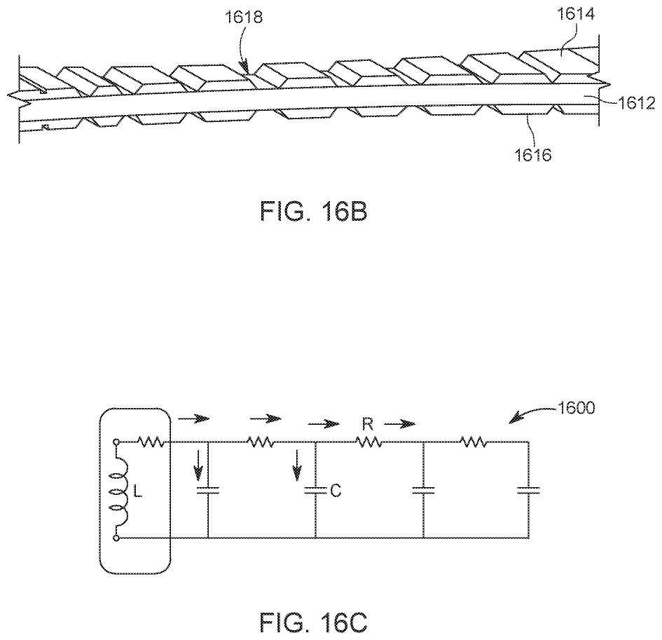

While the above embodiments discussed the sensor 100 being implemented with CNT based electrodes, it is also possible to use metals (gold, copper, aluminum, etc.) instead of CNT to achieve similar results. According to the embodiment illustrated in FIG. 16A, a wireless strain sensor 1600 is implemented with metal electrodes and its resonance frequency is used for determining the strain on a target object. The sensor 1600 communicates in a wireless manner, through inductive coupling 1602 with a readout coil 1604 of a portable device 1606, e.g., a smart device. While the figure shows the readout coil 1604 outside the portable device 1606, one skilled in the art would understand that the readout coil may be located within the portable device. Energy and/or data 1608 may be exchanged between the portable device and the sensor 1600. In one embodiment, the sensor 1600 has no power source and no processing electronics, only the elements shown in the figure, i.e., it acts as an LRC tag. One of the elements of the sensor 1600 are a coil L 1610 that serves as the interaction element with the portable device 1606. The coil 1610 is formed on a substrate 1612, for example, PDMS or polyimides. Further, the sensor 1600 includes electrodes 1614 (e.g., interdigited electrodes). In one application, similar electrodes 1616 are formed on the opposite side of the substrate 1612 to generate a capacitor, as shown in FIG. 16B. For this case, the substrate is selected to be a dielectric material. The difference between the electrodes 1614 and 1616 and the electrodes of the sensor 100 in FIG. 1 is that the present electrodes include metals while the sensor 100 has CNT in its electrodes. However, the sensor 1600 may also have its electrodes made of CNT, carbon-based nanoparticles, metallic based nanoparticles, etc.

FIG. 16B also shows the presence of cracks 1618 in the top and bottom electrodes. Thus, the transmission line model discussed above with regard to sensor 100 is also applicable herein, and the entire theory on which the method of FIG. 15 is based is not repeated herein, but is understood to be applicable to sensor 1600. However, one skilled in the art would understand, based on the embodiments discussed above, how to measure the strain characteristics. FIG. 16C shows an electrical equivalent schematic of the sensor 1600, with the inductance L standing for the coil 1610, the capacitors C standing for the capacitor formed by the first and second electrodes when formed on opposite sides of the dielectric substrate, and the resistance R for the resistance of the metal electrodes. At least one of the electrodes is made to have cracks or is made of a material that is prone to develop cracks during strain, so that the transmission line model is applicable.

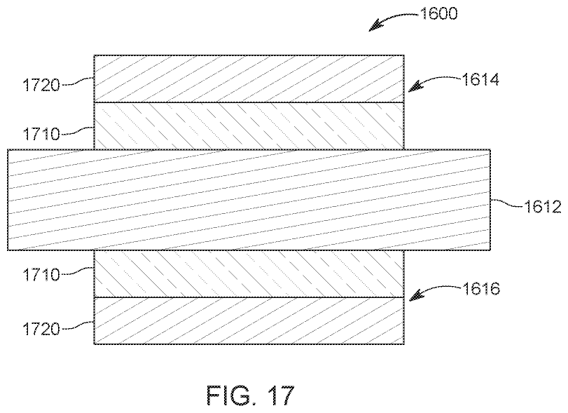

In one application, as illustrated in FIG. 17, the first electrode 1614 may be made of two layers, a first layer made of a brittle material 1710 (i.e., rigid and stiff), which is prone to cracking, like Cr, while a second layer is made of a flexible material 1720, which is not prone to cracking, like Au. Other combinations of metals may be used as long as the first layer, which is directly adjacent to the substrate 1612, cracks before the second layer, which is directly adjacent to the first layer. In one application, the first layer has a thickness of about 60 nm, the second layer has a thickness of about 20 nm, the substrate has a thickness of about 50 μm, and the substrate may be polyimide.

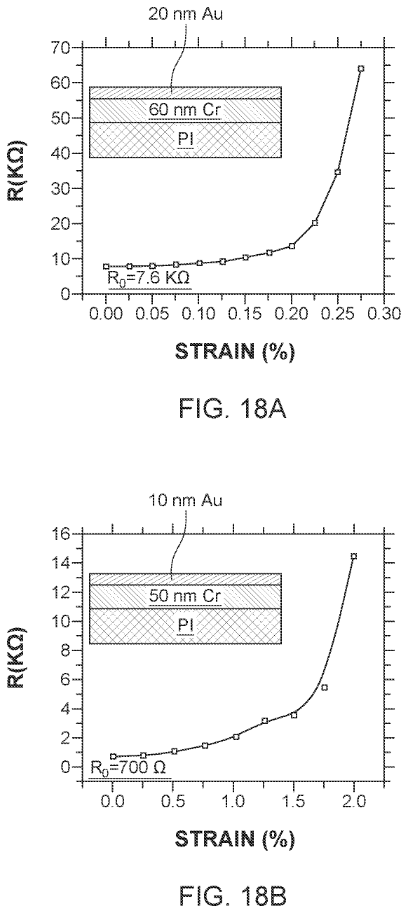

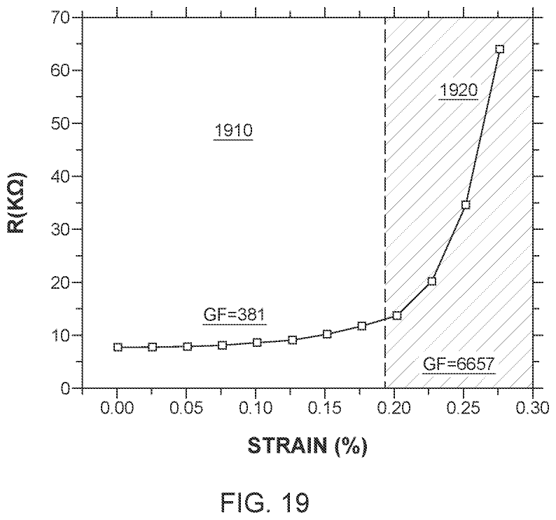

The cracks 1618 may be made intentionally, for example, as discussed above with regard to sensor 100, or may be induced by fatigue in the material. If the cracks are fatigue induced, they may not have a regular shape, but may follow whatever weak points are present in the material. The change in resistance in a Cr/Au electrode due to the cracking that appears in the Cr layer changes with the thickness of the layers, as shown in FIGS. 18A and 18B. Thus, the resistance variation of the sensor 1600 can be adjusted by controlling the thickness of the first and second materials 1710 and 1720. Note that originally the cracks start in the first material 1710 and then, as the strain increases, they propagate into the second material 1720. For these reasons, a graph that plots the resistance of the sensor versus the applied strain has two regions, as show in FIG. 19. A first region 1910 corresponds to an overlapping effect, where the resistance increases almost linearly with the strain, and a second region 1920 corresponds to a tunneling effect, where the resistance increases exponentially.

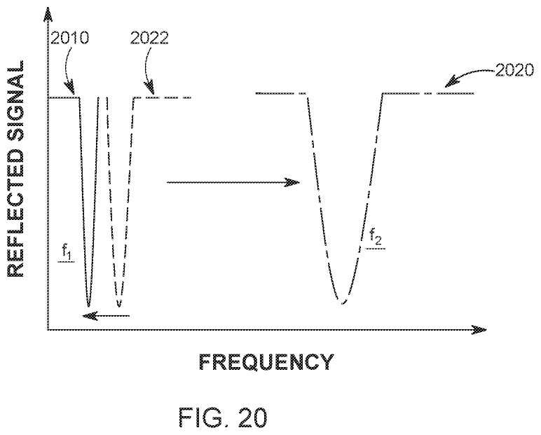

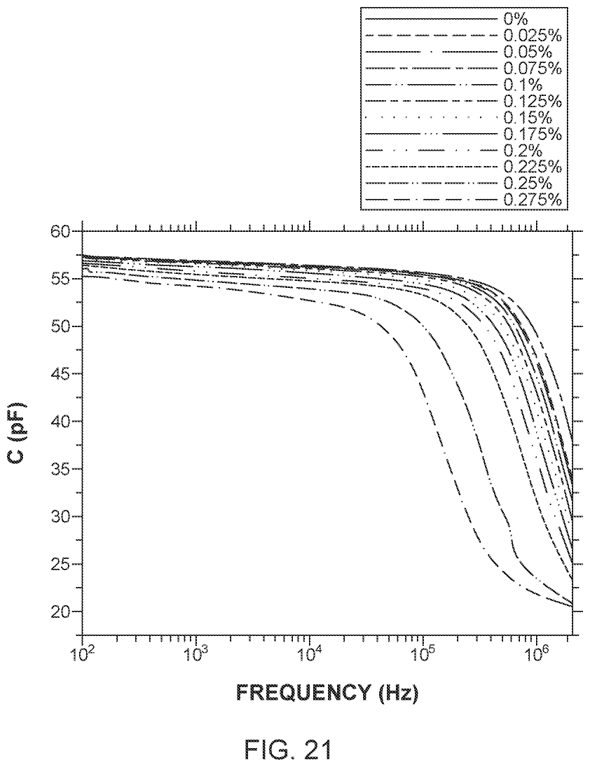

For the sensor 1600, the portable device 1606 injects into the coil 1610 of the sensor 1600 a first signal 2010 having a first frequency f1, and after this signal propagates along the sensor and back to the coil 1610, it is changed into a second signal 2020, having a second frequency f2, different from the first frequency f1, as shown in FIG. 20. The geometric effect slightly changes the frequency of the reflected signal as indicated by signal 2022, while the transmission line effect substantially shifts the frequency of the reflected signal (from f1 to f2). The frequency shift observed for signal 2022 appears when there are no cracks in the electrodes. The frequency shift f2−f1 appears due to the presence of the cracks. As the frequency shift f2−f1 is larger, it is easier to be detected and measured and thus, the system shown in FIG. 16A takes advantage of this increase frequency shift for determining the strain experienced by the sensor. A strain of 0.1% or higher can be detected with the sensor 1600. FIG. 21 shows the change in the capacitance of the sensor with the injected frequency for various strains. It is noted that the sensor is very sensitive to low strains.

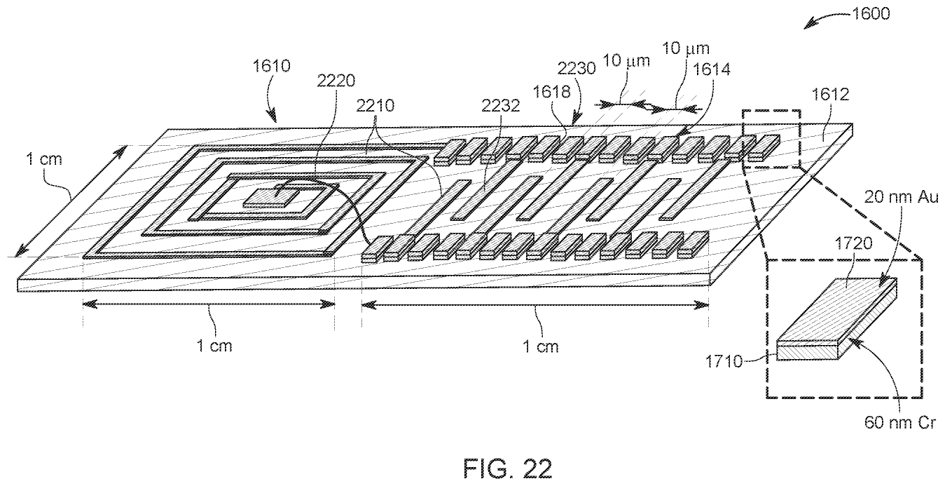

The sensor 1600 may be implemented as now discussed. A first possible implementation is shown in FIG. 22. In this implementation, all the electrodes are formed on top of the substrate 1612. The first electrode 1614 includes a Cr first layer 1710 and a second Au layer 1720. Cracks 1618 are initially present only in the first layer 1710, not in the second layer 1720. Reference number 2210 indicates areas of the sensor that have no cracks. The coil 1610 is connected with an electrical contact 2220 to the RC region 2230 of the sensor. The RC region 2230 includes interdigitate electrodes 1614, that form the capacitance C part of the sensor. Note that in this embodiment, there are no second electrodes 1616 on the other side of the substrate 1612. The capacitance C part is generated by the interdigitated electrodes. In this embodiment, it is possible to have 1000 fingers 2232 that form about 500 parallel capacitors. Not each electrode 1614 has a corresponding finger 2232. For this embodiment, the cracks 1618 take place in the electrodes 1614 and not in the fingers 2232.

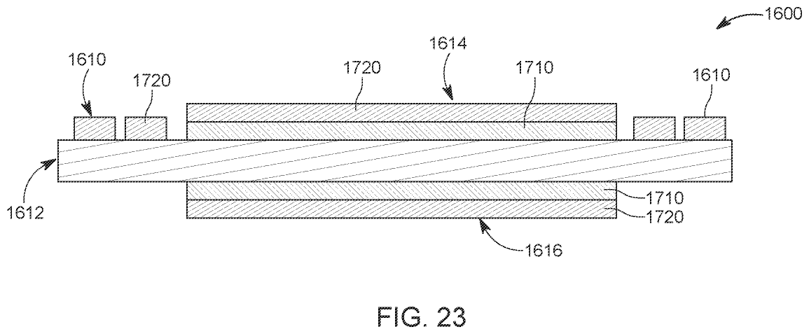

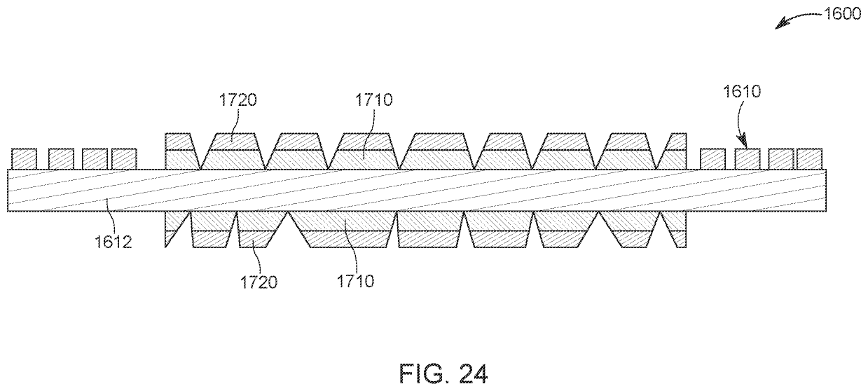

According to another embodiment, as illustrated in FIG. 23, the coil 1610 is formed around the first electrode 1614, and the second electrode 1616 is formed on the opposite side of the substrate 1612, relative to the first electrode 1614. In this embodiment, the interdigitated electrodes of the previous embodiment are changed to a parallel plate capacitor configuration to avoid fabrication problems. When the sensor 1600 is stretched in this implementation, both the first and second layers 1710 and 1720 crack, as shown in FIG. 24. Thus, the transmission line effect is present in this implementation of the sensor and the method discussed with regard to FIG. 15 is equally applicable to this embodiment. For this embodiment, the length L of the sensor may be between 20 and 300 mm, the width w of the sensor may be between 100 and 200 μm, and a thickness t of the sensor may be between 10 and 200 μm.

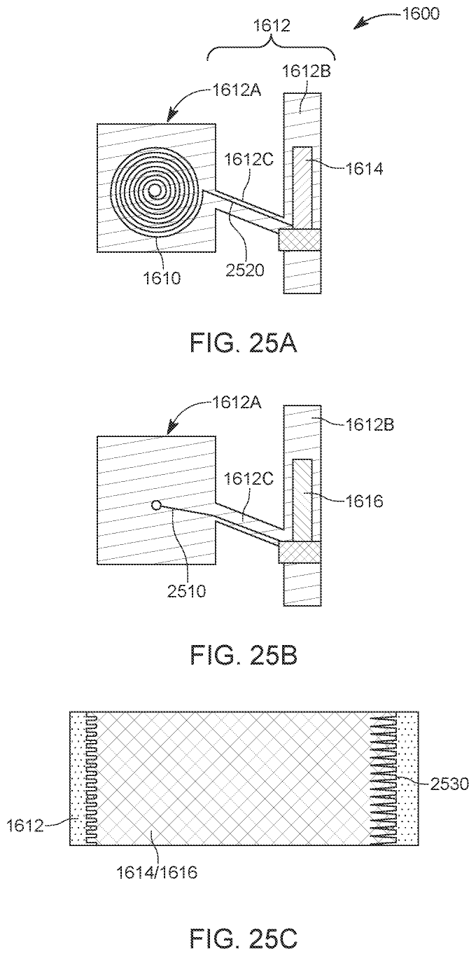

In yet another embodiment, as illustrated in FIGS. 25A to 25C, the coil 1610 is formed on a first face of the substrate 1612A and the first electrode 1614 is formed on the second face 1612B, where the two substrates 1612A and 1612B are separated from each other. On the second face of the first substrate 1612 there is a first contact line 2510 that connects one end of the coil 1610 to the second electrode 1616, which is formed on the second face of the second substrate 1612B. The contact line 2510 is supported by a connecting strip substrate 1612C, which connects the first substrate 1612A to the second substrate 1612B. The other end of the coil 1610 is electrically connected, by a second contact line 2520 to the first electrode 1614. FIG. 25C shows plural V notches 2530 formed in the electrodes 1614 and 1616 for promoting cracks when the strain is applied.

The sensor 1600 discussed above, due to its small size and footprint, may be implemented in a carbon-fiber reinforced polymer, e.g., the wing of an airplane, for determining in real time the strain applied to the wing. The sensor may also be embedded into a wind turbine, civil engineering structure (e.g., bridge), railway, oil and gas equipment (e.g., oil or gas transporting pipes), etc., for monitoring the strain in these structures. The strain is read with the portable device 1606. In one implementation, the portable device 1606 may be implemented on an air borne device, for example, a drone, that can be directed along the equipment to be monitored for reading the strain from plural strain sensors 1600. In essence, the sensor 1600 may be used as an RFID sensor, i.e., it may be placed on any structure that needs to be monitored for strain conditions.

The disclosed embodiments provide a strain sensor that is very small, can be embedded in any structure, and can determine various strain characteristics in addition to the strain intensity. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] White, E. L., Yuen, M. C. ε Kramer, R. K. Distributed sensing in capacitive conductive composites. in 2017 IEEE SENSORS 1-3 (IEEE, 2017).
[2] Sonar, H. A., Yuen, M. C., Kramer-Bottiglio, R. & Paik, J. An any-resolution pressure localization scheme using a soft capacitive sensor skin. in 2018 IEEE International Conference on Soft Robotics (RoboSoft) 170-175 (2018). doi:10.1109/ROBOSOFT.2018.8404915.
[3] Xu, D., Tairych, A. & Anderson, I. A. Stretch not flex: programmable rubber keyboard. Smart Mater. Struct. 25, 015012 (2015).
[4] Xu, D., Tairych, A. & Anderson, I. A. Where the rubber meets the hand: Unlocking the sensing potential of dielectric elastomers. J. Polym. Sci. Part B Polym. Phys. 54, 465-472 (2016).
[5] Nesser, H., Lubineau, G., ACS Appl. Mater. Interfaces 2021, 13, 30, 36062-36070 (2021).

1. A strain characterization system comprising:
a strain sensor having first and second electrodes that sandwich a dielectric layer to form a capacitor;
a power source configured to inject a signal V_{AC} between the first and second electrodes of the strain sensor; and
a controller configured to control the power source and to select a frequency of the power source,
wherein the controller is configured to select first to third different frequencies for determining a strain magnitude, a strain location, and an extent of a strain area.

2. The system of claim 1, wherein the controller is configured to select,
the first frequency in a first frequency range, to determine the strain magnitude based on a first response of the strain sensor,
the second frequency in a second frequency range, different from the first frequency range, to determine the strain location based on a second response of the strain sensor, and
the third frequency in a third frequency range, different from the first and second frequency ranges, to determine the extent of the strain area based on a third response of the strain sensor.

3. The system of claim 2, wherein the first frequency range is between 100 Hz and 1.5 kHz, the second frequency range is between 1.5 kHz and 45 kHz, and the third frequency range is between 45 kHz and 1 MHz.

4. The system of claim 1, wherein the controller is configured to calculate an effective capacitance of the strain sensor for each of the first to third frequencies, and to determine the strain magnitude, the strain location, and the extent of the strain area based on the calculated effective capacitances.

5. The system of claim 1, wherein at least one of the first and second electrodes is configured to crack when a strain is applied to the strain sensor.

6. The system of claim 5, wherein cracks are formed periodically in the at least one of the first and second electrodes.

7. The system of claim 6, wherein the cracks increase a resistance of the first and second electrodes and make a transmission line model applicable to the first and second electrodes.

8. The system of claim 1, wherein the first and second electrodes include carbon nanotubes and the dielectric layer is flexible, so that after the strain is removed, cracks that appear in the first and second electrodes disappear as the dielectric material contracts the first and second electrodes.

9. A method for determining strain characteristics with a single strain sensor, the method comprising:
applying a strain sensor to a target object, the strain sensor having first and second electrodes that sandwich a dielectric layer to form a capacitor;
selecting with a controller a frequency of a signal V_{AC} to be injected into the strain sensor;
applying the signal V_{AC} to the first and second electrodes of the strain sensor, with a power source;
measuring a return signal from the strain sensor and determining a capacitance of the strain sensor; and
estimating a strain magnitude, a strain location, and an extend of a strain area experienced by the strain sensor based on the return signal,
wherein each of the strain magnitude, the strain location, and the extent of the strain area is measured at a different frequency.

10. The method of claim 9, wherein the strain magnitude, the strain location, and the extent of the strain area are measured with the same first and second electrodes.

11. The method of claim 9, wherein the controller is configured to select,
the first frequency in a first frequency range, to determine the strain magnitude based on a first response of the strain sensor,
the second frequency in a second frequency range, different from the first frequency range, to determine the strain location based on a second response of the strain sensor, and
the third frequency in a third frequency range, different from the first and second frequency ranges, to determine the extent of the strain area based on a third response of the strain sensor.

12. The method of claim 11, wherein the first frequency range is between 100 Hz and 1.5 KHZ, the second frequency range is between 1.5 kHz and 45 kHz, and the third frequency range is between 45 kHz and 1 MHz.

13. The method of claim 9, further comprising:
calculating an effective capacitance of the strain sensor for each of the first to third frequencies; and
determining the strain magnitude, the strain location, and the extent of the strain area based on the calculated effective capacitances.

14. The method of claim 9, wherein at least one of the first and second electrodes is configured to crack when a strain is applied to the strain sensor.

15. The method of claim 14, wherein cracks are formed periodically in the at least one of the first and second electrodes, wherein the cracks increase a resistance of the first and second electrodes and make a transmission line model applicable to the first and second electrodes, and wherein the first and second electrodes include carbon nanotubes and the dielectric layer is flexible, so that after the strain is removed, cracks that appear in the first and second electrodes disappear as the dielectric material contracts the first and second electrodes.

16. A wireless strain sensor configured to measure a strain in a target, the wireless strain sensor consisting of:
a dielectric substrate having a first part and a second part connected to each other through a strip third part;
a coil formed on the first part;
a first electrode formed on a first face of the second part; and
a second electrode formed on a second face of the second part, opposite to the first face,
wherein each of the first and second electrodes is configured to crack when the strain is present.

17. The wireless strain sensor of claim 16, wherein there is no battery or processor or memory on the dielectric substrate.

18. The wireless strain sensor of claim 17, wherein each of the first and second electrodes comprises:
a first material located directly on the dielectric substrate; and
a second material located directly on the first material,
wherein the first material is brittle so that the first material cracks when the strain is applied, and
wherein the second material is flexible so that the second material cracks later than the first material.

19. The wireless strain sensor of claim 18, wherein the first material is chromium, and the second material is gold.

20. The wireless strain sensor of claim 18, wherein the first material has crack initiators.
